(19) United States
(12) Patent Application Publication
(10) Pub. No.: US 2012/0119562 A1
(43) Pub. Date: May 17, 2012

(54) MINE SAFETY SYSTEM

(76) Inventors: Winchester E. Latham, Avon, IN (US); Mark W. Polo, Simpsonville, SC (US)

(21) Appl. No.: 13/293,217

(22) Filed: Nov. 10, 2011

Related U.S. Application Data
(60) Provisional application No. 61/412,948, filed on Nov. 12, 2010.

(51) Int. Cl. E21F 11/00; E21F 17/00; E02F 5/08; F16L 1/028

(52) U.S. Cl. 299/12; 405/184.4; 299/19; 37/94

(57) ABSTRACT

A mine safety system having at least a substantial portion of a mine conduit buried within a trench that is formed in the mine floor is provided. The mine safety system can be sturdy and durable in construction and in operation because a substantial pressure from a mine collapse is transferred to the surrounding earth or soil when the mine conduit is partially or fully buried in the mine floor. The mine safety system can be simply and inexpensively installed in newly constructed mines or retrofitted in existing mines. The mine conduit can be made of a lightweight plastic which can make handling of the conduit easier. Moreover, installation of the trench and the mine safety system is quicker and easier with use of a cutter drum that can form a curved trench bottom when the conduit is circular.

### CROSS-REFERENCE TO RELATED APPLICATION

This application is related to and claims all available benefit of U.S. Provisional Application Ser. No. 61/412,948 filed Nov. 12, 2010.

### BACKGROUND

This disclosure generally relates to systems for enhancing the safety and welfare of underground miners, and particularly to the installation of the systems within ditches or trenches with the mine.

Underground mining currently accounts for over one-half of the world's coal and mineral production. In underground mining, a seam of coal or mineral extending underneath the surface of the earth is mined typically using the room and pillar or board and pillar method along the seam. Entrance ways are formed at the open face of the seam, where at least one vertical shaft is formed extending into the seam. Conventionally, two or three substantially parallel, vertical shafts are formed, with one or two vertical shafts being conduits for pumped fresh air and one vertical shaft being a conduit for return air and for an escape route for miners who have to exit for any condition. Laterally extending deeper into the coal or mineral seam are lateral shafts that communicate with the vertical shafts at various levels within the underground mine system. The lateral shafts are formed, generally leaving pillars and timber spaced apart, standing to support the coal mine roof that may be in danger of collapsing. Between the pillars for the mine roof, floor or sidewalls, there may be regions of minimal to no support and there may be still a substantial danger of roof collapse or rib deterioration.

Various mechanisms are available to permit mine workers to escape in case of a disaster. For example, U.S. Pat. No. 964,563 to Sasse teaches a series of multiple, lateral tubular ducts above the mine floor, where a mine worker can enter into and crawl to an escaped shaft. The tubular ducts interconnect laterally with perpendicular tubular ducts and vertically by other tubular ducts, where all of the tubular ducts form a pathway leading to the escape shaft. Provided along the length of the lateral tubular ducts is a plurality of inlet openings spaced apart to permit entry by the mine worker into the pathway of escape. However, with the tubular duct being above ground along the mine floor, the tubular ducts are susceptible to being crushed during a roof collapse. Another example is U.S. Pat. No. 3,164,079 to Ross, which teaches a main conduit communicating with a series of branch conduits having a series of emergency stations, with each conduit being made of heavy gauge galvanized pipe. However, the conduits and emergency stations are also above ground along the mine floor and susceptible to being crushed during a roof collapse.

Thus, there remains a need for a mine safety system that provides an enclosed conduit adapted to withstand a roof collapse. There also remains a need for a quicker and easier method of trenching and installing a mine safety system in a newly constructed mine and/or in an existing mine.

### SUMMARY

In a first embodiment, a mine safety system for a mine having a floor, a roof, and a pair of sidewalls is provided. A trench can be formed in the mine floor. A mine conduit can be disposed in the trench. The mine conduit can include a wall defining an internal passage. A portal can be positioned along the mine conduit, where the portal is configured to provide external access to the internal passage of the mine conduit. At least one of a telecommunication means and a ventilation supply means can be disposed within the internal passage of the mine conduit. The telecommunication means and the ventilation supply means can be accessible through the portal. The trench has a depth sized to be preferably at least 60% of a height of a cross-section of the mine conduit so that a substantial portion of the mine conduit is buried within said mine floor.

In a second embodiment, a method of installing a mine safety system in a mine is provided. A mine conduit can be provided having a wall defining an internal passage. A trench can be formed at a selected depth in the floor of the mine, where the selected depth sized to be at least 60% of a height of a cross-section of the mine conduit. The mine conduit can be inserted within the trench so that at least a substantial portion of the mine conduit is within the trench. A portal can be formed in the wall of the mine conduit. The portal is configured to provide external access to the internal passage of the mine conduit. The trench can be backfilled around an exterior surface of the mine conduit, so that so that a substantial portion of the mine conduit is buried within the mine floor.

In a third embodiment, a cutter drum for a trenching machine is provided. The cutter drum can include a cylindrical member configured to rotate about a horizontal axis. The cylindrical member can have a curved peripheral surface of an axial width uniformly spaced from the horizontal axis. A plurality of cutting tooth assemblies can be mounted to the peripheral surface. Each cutting tooth assembly can extend outward from the peripheral surface and can have a distal tip. The distal tips of the cutting tooth assemblies can be configured and arranged to form an arcuate periphery capable of forming a trench having an arcuate bottom surface.

The above, as well as other advantages of the present system, will become readily apparent to those skilled in the art from the following detailed description of a preferred embodiment when considered in the light of the accompanying drawings.

### BRIEF DESCRIPTION OF THE DRAWINGS

FIG. 1A is an elevation view depicting a mine safety system installed within a lateral tunnel.

FIG. 1B is a cross-sectional view taken along line 1B-1B of FIG. 1A depicting the lateral tunnel and the proximity of a mine conduit of the mine safety system.

FIG. 2 is a front view of a cutter drum of a trenching machine depicting the shape of a trench.

FIG. 3 is a perspective rear view of a cutter drum depicting the shape of a trench.

FIG. 3A is a side view of the cutter drum in FIG. 3.

FIG. 4A is an elevation view of a mine conduit of the mine safety system.

FIG. 4B is an elevation view of a pipe and an abutting pipe to form a mine conduit of the mine safety system.

FIG. 5A is a cross-sectional view taken along line 5A-5A of FIG. 1A depicting a portal of the mine conduit of the mine safety system.

FIG. 5B is a downward view taken along line 5B-5B of FIG. 5A depicting the mine conduit of the mine safety system.

FIG. 6 is an end view of a life source conduit.

### DESCRIPTION OF PREFERRED EMBODIMENTS

The various embodiments described herein relate to a mine safety system and method of installing a mine safety system. The mine safety system can provide telecommunication and ventilation, as well as nutrients and water, during normal operation hours and during an emergency. In some examples, the mine safety system can provide a way to escape to safety in the event of a collapse or emergency. The mine safety system can be sturdy and durable in construction and in operation because the vertical force and pressure of a roof or sidewall collapse are transferred to the surrounding earth or soil when the mine conduit is partially or fully buried in the mine floor. The mine safety system can be simply and inexpensively installed in newly constructed mines or retrofitted in existing mines. The mine conduit can be made of a plastic, for example a corrugated high density polyethylene plastic, which is light weight. This can permit fewer required people to handle the conduit, reduced use of heavy-equipment requirements, and longer lengths to handle with fewer joints. Moreover, installation of the trench and the mine safety system is quicker and easier with use of a cutter drum that can form a curved trench bottom when the conduit is circular.

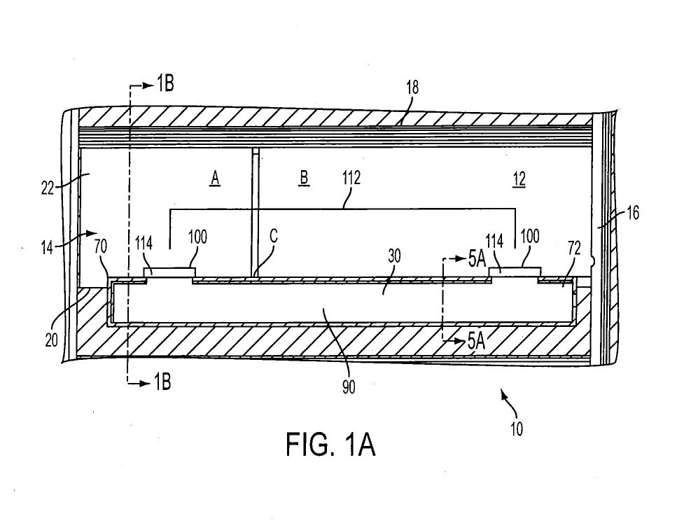

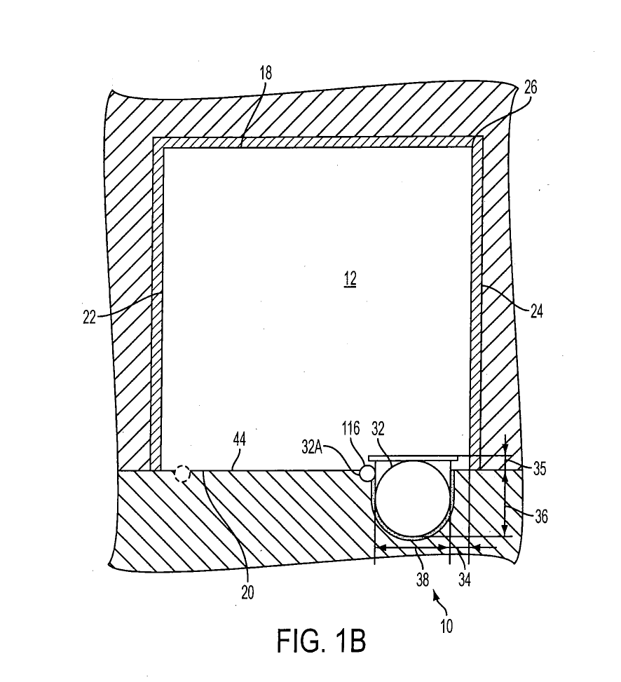

FIG. 1A shows one embodiment of a mine safety system 10 within a conventional underground mine 12. The mine 12 shown includes an elongated lateral tunnel 14 in communication with a vertical shaft 16. The mine 12 can include any number of lateral tunnels 14 and vertical shafts 16, and FIG. 1A is merely illustrative. Also illustrated with the lateral tunnel 14 are three particular areas of concern: distal area A that is distal to a potentially collapsed area or collapsed area C, and a proximal area B that is proximal to the collapsed area C and is considered a direction of or toward safety. FIG. 1B is a cross-sectional view taken along line 1B-1B of FIG. 1A depicting the lateral tunnel 14 and the proximity of a mine conduit 30 of the mine safety system 10. In FIG. 1B, the elongated lateral tunnel 14 has a roof 18, a floor 20, and a pair of sidewalls 22, 24 therebetween each forming the circumference 26 of the lateral tunnel 14. The mine conduit 30 can be implanted or imbedded into a trench 32 in the tunnel floor 20 of a newly constructed mine or retrofitted into a previously existing mine. By partially or fully burying the mine conduit 30, the force and pressure of the collapse are transferred to the surrounding earth or soil. Hence, the mine conduit 30 can withstand a roof collapse and maintain its structural and mechanical integrity.

Referring to FIG. 1B, the trench 32 can be positioned anywhere in the tunnel floor 20. Preferably, the trench 32 is constructed along at least one of the tunnel sidewalls 22, 24 at an effective distance 34 from the sidewalls 22, 24 as not to interfere with the structural integrity of the tunnel sidewalls 22, 24. The effective distance 34 can be about 8 inches to about 12 inches at a minimum, although the distance can be less as determined by one skilled in the art. It may also be desirable for the trench 32 to be substantially parallel with the tunnel sidewalls 22, 24. In some instances, it may be desirable to place the mine conduit underneath a system of conveyor belts that can be found in the mine for moving mined articles or dirt. The conveyor belt system may even further protect the mine conduit in case of a roof collapse.

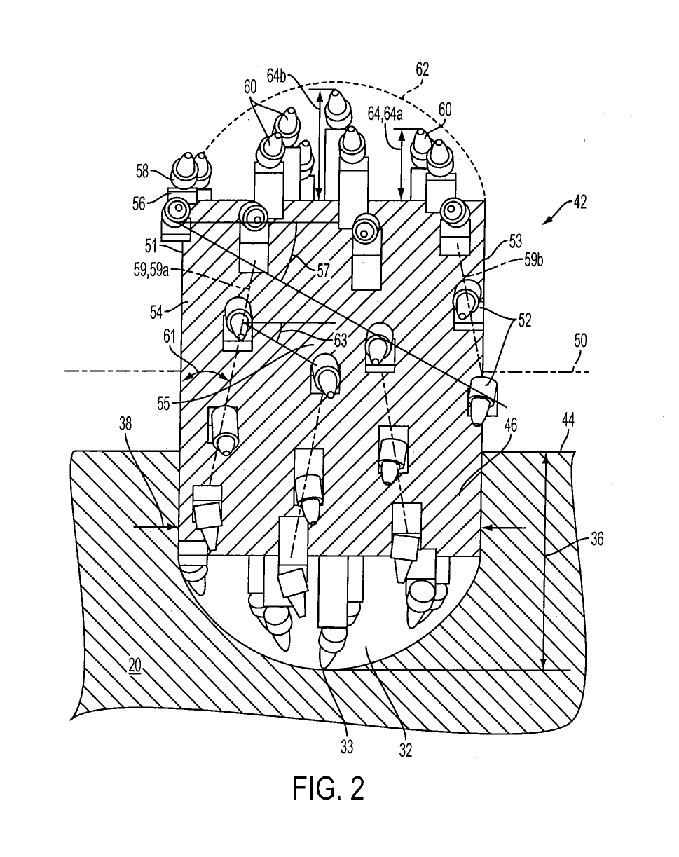

The depth 36 and the width 38 of the trench 32 are shown in FIGS. 1B and 2. The trench width 38 can be slightly larger by up to approximately 20% than the cross-sectional width of the mine conduit 30 to be received. For example, for a nominal 30-inch diameter pipe, the trench width 38 can be about 34 inches. Earth, dirt, and dust can be allowed to enter into any gaps between the trench 32 and mine conduit 30 once installed in the trench. The trench depth 36 should be an effective distance to permit the tunnel floor 20 to absorb a substantial amount of force and stress and to protect the mine conduit 30 from being crushed during a mine collapse.

In some embodiments, the trench depth 36 can be less than or more than the cross-sectional height of the mine conduit 30 to be received. For example, for a nominal 30-inch diameter pipe, the trench depth 36 can be at least about 20 inches, or at least about 60-75% the height of the mine conduit 30. In this regard, as shown in FIG. 1B, a portion of the mine conduit 30 extends beyond the tunnel floor 20 at a suitable distance 35. This arrangement can permit a cost-effective means in constructing the trench 32 to a small enough depth as necessary and an easier and quicker access in case of an emergency since a portion of the conduit can be seen above ground. In another example, the trench depth 36 can be at least about 34 inches, permitting the mine conduit 30 to be buried just beneath a surface 44 of the tunnel floor 20 in order to protect potentially the entire mine conduit 30 from a roof collapse. The trench can have a cross-section sized and shaped similar to a portion of the cross-section of the mine conduit.

The mine conduit may 30 be sized to only contain a communication means, nutrient means, air means, etc. as described in more detail below. In one example, a second trench 32A may also be created within the mine floor 20 in addition to the trench 32. The second trench 32A may be smaller is cross-sectional area than the trench 32 and sized to receive the smaller mine conduit. The second trench 32A may be placed adjacent the mine conduit 32 or along any portion of the mine floor such as adjacent the opposite sidewall (shown by dashed lines in FIG. 1B). In another example, portions of mine can include only the trench 32A that is sized to receive the smaller mine conduit. In other words, the mine floor would not include a mine conduit sized large enough for a mineworker to crawl through. Indeed, some mine systems may include only a mine conduit sized for a mineworker to crawl through, only a mine conduit sized smaller for a communication means, nutrient means, air means, etc., or any combination of both.

The trenches 32, 32A can be constructed from various means known in the art, but the trenches are preferably constructed with a trenching machine, which is not shown. The trenching machine can include a rotary driven comminuting cutter drum 42 which acts to plow or cut the tunnel floor surface 44 in situ. As can be appreciated by one skilled in the art, the trenching machine can also include a chassis and a plurality of transport assemblies mounted to the chassis for permitting movement of the trenching machine along a selected path 46. The transport assemblies can include ground engaging wheel assemblies in the form of a conventional track, rail engaging wheel assemblies to engage a railroad, or any other transporting assembly known in the art. A prime mover means can be mounted to the chassis for advancing the trenching machine in at least a forward direction 48. The prime mover means can include an engine or electric motor, for example. The trenching machine can cut or plow a trench at a rate of about 8 to 10 feet per minute (FPM) or faster depending on the size of the trench and the construct and materials of the tunnel floor 20.

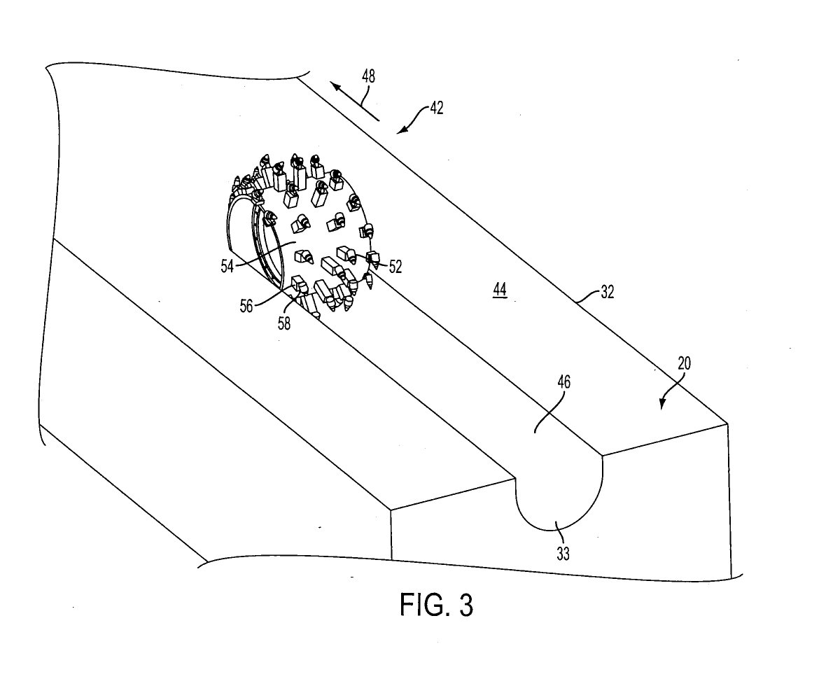

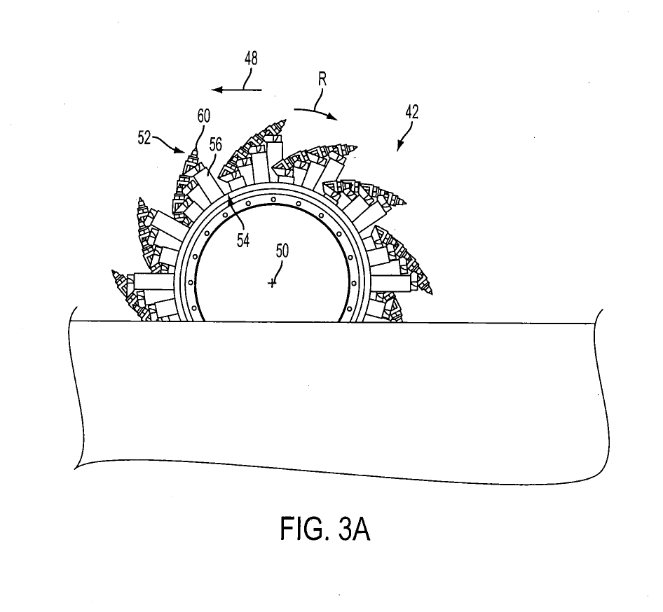

The cutter drum 42 can be coupled to the prime mover means. According to FIGS. 2, 3, and 3A, the cutter drum 42 can be cylindrical and can rotate about a generally horizontal axis 50 in a rotational direction R opposite the forward direction 48. The cutter drum 42 is connected to the chassis in a manner so as to form the trench as the trenching machine moves in a forward direction 48. The cutter drum 42 can include a plurality of cutting tooth assemblies 52 coupled to the surface 54 of the cutter drum 42. Optionally, the cutter drum 42 may include a flighting on the cutter drum 42 which acts to collect the material toward the center of the cutter drum 42 where it can be removed. A reclamation means for collecting loosened material can be also provided. The loosened, reclaimed material can be collected onto a pan line, taking the material to the conveyor belt for removal from the work area to the above ground surface where coal or other minerals is further processed.

The cutting tooth assembly 52 can be securely engaged with a support member 56 that is connected to the surface 54 of the cutter drum 42, or to the flighting, by bolts or by weld. Each support member 56 can be arranged so as to space apart each of the cutting teeth 52, as shown in FIGS. 2 and 3, for example to space each cutting tooth assembly laterally and circumferentially from another. In one example, the cutting tooth assembly can be arranged in a helical pattern along the circumferential surface of the cutter drum 42. For example, a helical pattern 59a can begin from a lateral edge 51 on the left portion of the drum surface 54 and end at an intermediate portion 55 of the drum surface 54. A second helical pattern 59b can begin from the lateral edge 53 on the right portion of the drum surface 54 and end at the intermediate portion 55 of the drum surface 54. The elevation of the cutting tooth assemblies can change in an axial direction along the axial width, but also can change incrementally in a circumferential direction with each sequential cutting tooth assembly in the helical pattern. As shown, the helical pattern can be angled toward the middle of the drum by an angle 61 of about 5 to about 20 degrees relative to an axis perpendicular to the horizontal axis 50. The helical pattern can be circumferentially offset from the other helical pattern by an angle 57 of up to about 40 degrees. Each cutting tooth assembly in a helical pattern can be offset from an adjacent cutting tooth assembly in the same pattern by an angle 63 of up to about 40 degrees.

An outer extremity 60 of the cutting tooth assembly 52 can be configured to define a periphery 62 having a desired shape. The outer extremity 60 can vary by locating a top surface 58 of the support members 56 at different elevations from the drum surface and/or length of the cutting tooth that is inserted in the support member. The top surface 58 can include angled openings into which a cutting tooth 52 is received. The cutting teeth 52 can include a conical cutter with preferably a tungsten carbide tip or the like. Optionally, the openings of the support member 56 may instead include inserts for the cutting tooth that are removably mounted to the cutting teeth support members 56, for instance by threaded attachment. Other features for the drum 42 and the cutting tooth assembly 52 and their attachment can be found in U.S. Pat. No. 5,842,747 to Winchester Latham, which is incorporated herein by reference.

Referring to FIG. 2, the periphery 62 can be defined by varying the extension distance 64 of the cutting teeth 52, the support members 56, or both. The extension distance 64 is defined as the distance from the surface 54 of the cutter drum 42 to the outer extremity 60 of the cutting teeth 52. The shape of the periphery 62 can take a form based on the desired shape of the trench 32, which is generally dictated by the shape of the mine conduit, discussed below. For example, when circular pipe is used for the mine conduit, the trench 32 preferably has a circular or semi-circular cross section, that is, a trench bottom surface 33 having a curvature. Consequently, the periphery shape will likewise be curved or semi-circular, such as forming an annular shape. The trench can have substantially vertical sidewalls coupled to the arcuate bottom surface. FIG. 2 illustrates the periphery 62 having a curvature, where the cutting teeth 52 along the lateral edges 51, 53 of the cutter drum 42 have an extension distance 64a that is shorter than an extension distance 64b of the cutting teeth 52 along the middle portion 55 of the cutter drum 42. In this manner, the formed trench 32 is suitably sized and shaped to allow an increased installation rate of the conduit by at least partially if not completely eliminating back filling after a conduit is installed in the trench.

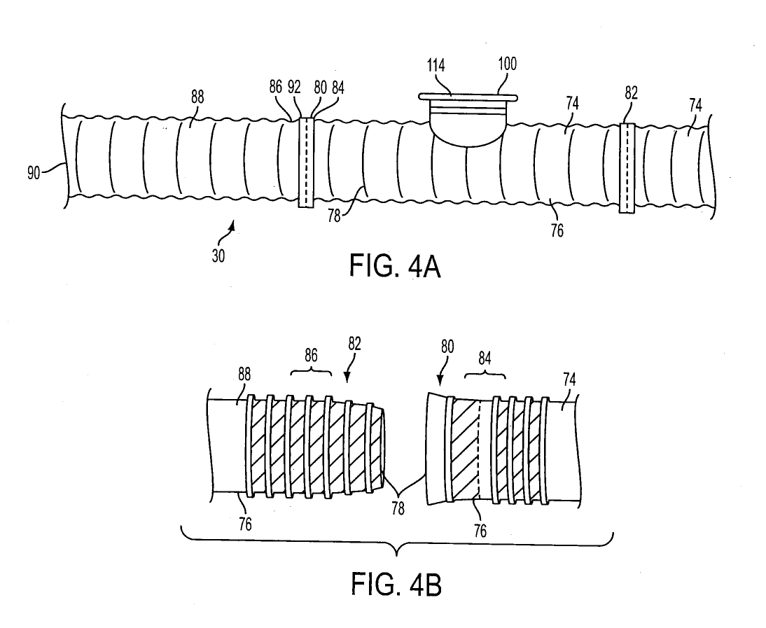

Referring to FIGS. 1A, 4A, and 4B, the mine conduit 30 can include a first end 70 and a second end 72 opposite the first end 70, with the first end 70, second end 72, or both, leading to a way of escape. The mine conduit 30 can be constructed of a series of pipes 74 of any material known in the art suitable to withstand an impact on the top due to a roof collapse after being installed as described herein. The pipe 74 is shown to be circular although other shapes like elliptical and rectangular may be used. The pipe 74 can have a wall 76 to define a passageway 78, a first end 80, and a second end 82 opposite the first end 80 to define a length of each pipe. The pipe 74 can include a first connection means 84 at the first end 80 and a second connection means 86 at the second end 82. The first connection means 84 of one pipe 74 can securely engage with the second connection means 86 of an abutting pipe 88. The abutting pipe 88 preferably has substantially identical characteristics as the pipe 74. When the pipes 74, 88 are securely engaged, the passageway 78 of each pipe 74, 88 is in communication to define a continuous passage 90 within the mine conduit 30.

The pipe 74 can include variable lengths, diameters, and connections. For example, the pipe 74 may be a 30-inch diameter pipe supplied in 20-foot lengths having a male connection end and a female connection end for the first and second connection means 84, 86. As shown in FIG. 4B, the male end of one pipe 88 and the female end of another pipe 74 can be securely engaged to one another. The male end can include a decreasingly tapered spigot sized to be inserted in the female end. The female end can include an increasingly tapered bell sized to enclose the male end. A sealing material can be used along the joint of the first and second connection means 84, 86 for sealing purposes. The sealing material can include caulk, an adhesive, and a gasket such as rubber gasket or another composite. The wall of the pipe may be segmented in reinforcing rings or be corrugated for added strength. It is preferable if the connection between the pipes be soil-tight, watertight, airtight, or any combination thereof. The pipe can be made of metal or plastic. One preferred pipe used for pipe 74 is a corrugated high density polyethylene (HDPE) pipe, sold under the N-12 trademark owned by Advanced Drainage Systems, Inc. of Hilliard, Ohio. The HDPE corrugated pipe is found to be lightweight and still have the structural integrity for a mining environment. Other details for a type of pipe can be found in U.S. Pat. No. 5,765,880, which is incorporated by reference.

In another embodiment, each of the first and second connection means 84, 86 can be securely engaged with a collar 92 enclosing the first connection means 84 of one pipe 74 and the second connection means 86 of the abutting pipe 88, as shown in FIG. 4A. Here, the collar 92 is positioned around the joint and attached to the pipes 74, 88 to provide further sealing and rigidity at the connection. Because of lightweight material of the pipe 74, the shipping costs may be decreased, fewer people may be needed to handle the pipes, heavy-equipment requirements may be reduced, and longer lengths may be easier to handle and may require fewer joints.

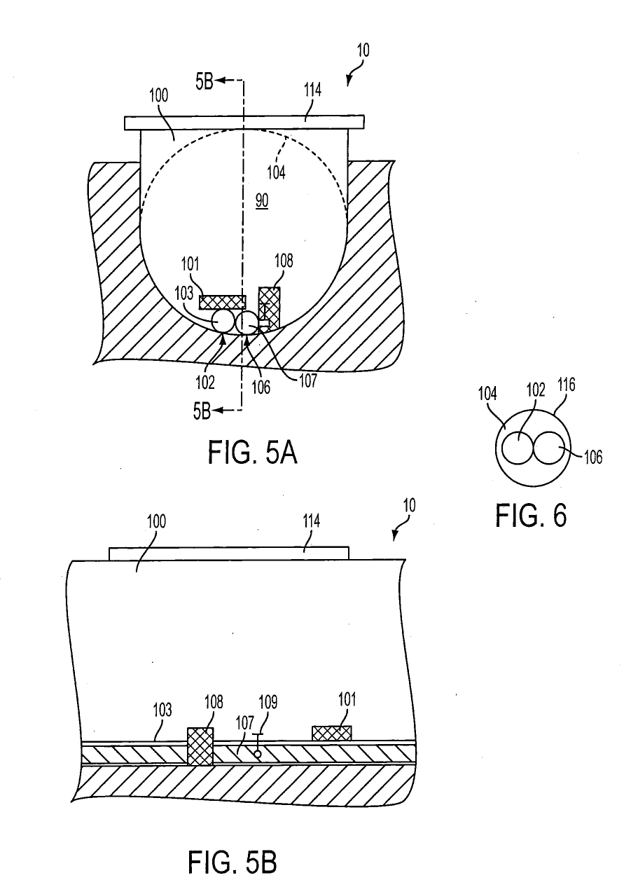

A portal 100 is shown in FIGS. 1A and 4A. The portal 100 is an access point to the passage 90 of the mine conduit 30. Portal 100 can be sized to allow a mine worker to fit within when the passage is sized for a mine worker to escape. Portal 100 may also provide access to a telecommunication means 102 for communicating to people external to the mine 12, a means 104 for supplying fresh air, or both, the can be disposed with the mine conduit. Portals 100 can also provide a means 106 for supplying water, food or nutrients 108, a first aid kit, or any combination thereof. FIG. 5A is a cross-sectional view taken along line 5A-5A of FIG. 1A depicting the portal 100 of the mine conduit 30 of the mine safety system 10, while FIG. 5B is a downward view taken along line 58-5B of FIG. 5A, each illustrating a mere proximity of the communication means 102, the means 104 for supplying fresh air, the means 106 for supplying water, food 108, a first aid kit within the mine conduit. It is understood that the particular proximity shown is not limiting and can be any arrangement and configuration known by one of ordinary skill in the art.

Depending on the run of the elongated lateral tunnel 14 and the makeup of the surrounding tunnel, a single portal 100 can be provided into the mine conduit 30, being spaced from one of the first and second ends 70, 72 of the mine conduit 30 by a suitable distance. More than likely, however, a plurality of portals 100 are provided into the mine conduit 30, each spaced apart from one another by an effective distance 112. The effective distance 112 for spacing is determined generally by the geometry, length, and make-up of the tunnel. Preferably, each portal 100 is spaced apart from one another equally by an effective distance 112 of up to about 250 feet or more. The portals 100 are generally T-shaped and can vary in size depending on the intended use. It is desirable, however, for the cross-sectional area or diameter of the portal 100 to be similar to the cross-sectional area or diameter of the pipe 74. It is also desirable that each portal 100 have a cap 114. The cap 114 can be sealably engaged with the portal 100 and can be removed when access to the mine conduit passage 90 is desired. The cap 114 can also be hinged and therefore would swing to one side when removing. It is to be understood that the removal of the cap 114 means that the cap 114 is removed from the portal opening and is not limited by bodily removing the entire cap 114 from the portal 100. Furthermore, the cap 114 includes a means for removing on the inside and outside of the cap 114, thereby allowing an operator to remove the cap 114 from the inside of the mine conduit 30, as well as, from the outside.

In accordance with FIGS. 5A and 5B, the telecommunication means 102 can comprise of a hard wire communication system having a communication supply line 103 extending throughout the passage 90 of the mine conduit 30. The communication supply line 103 is preferably an air-tight and vacuum tight conduit containing the communication wires. Portions of the communications supply line 103 can extend to the portal 100. There, the communication wires extend through fittings to connect to a communication device, such as an intercom 101, telephone or the like, located within the portal 100. The one end of the communications supply line 103 is located exterior to the mine 12, where the communication wires connect to the communication device, such as an intercom, a telephone or the like, located exterior to the mine 12 to establish telecommunication between the exterior of the mine 12 and the portals 100. Some portals 100 may only contain jacks where a communication receiver can connect, while some portals 100 may contain only the intercom.

The means 104 for supplying fresh air or ventilation can include connecting an air blower to the end of the mine conduit 30 that is exterior to the mine 12. An air blower may also be configured to withdraw air from the mine that may be dangerous to breathe, such as air containing high levels of methane or carbon dioxide. The air blower can pump ventilation or fresh air within the mine conduit 30, sufficient for a mine worker to maintain breathing within the passage 90 of the mine conduit 30. Alternatively, fresh air can be pumped so that fresh air travels through an opened portal 100 into the distal area A that is distal to the collapsed area C. Optionally, pressurized air can be introduced through a separate conduit within the mine conduit to introduce air to the mine worker. Regulation of the supply air to the mine and/or the return air from the mine can be sufficient to sustain a breathable environment for the mine worker until rescue, as appreciated by one skilled in the art. During normal mining operations, i.e., non-emergency period, the mine conduit system can be used as the means to supply ventilation throughout the mine.

The means 106 for supplying water can include a water supply line 107 extending throughout the passage 90 of the mine conduit 30 to supply water to the distal area A until rescue. Portions of the water supply line 107 can extend to the portal 100 from a water source that is exterior to the mine 12. At each portal 100 there can be a water outlet 109. Some portals 100 may not contain the water outlet. Food 108, in any form that can be preserved for an extended time, such as nuts, dried food, liquid food or the like, can also be found at some of the portals 100, preferably, in airtight containers. In this case, the food supply can sustain several mine workers for a multiple days. Moreover, first aid kits can also be found at some of the portals 100, preferably, in airtight containers. Any of the life sustaining elements such as nutrients or food may also be pushed or otherwise forced through a separate conduit to reach the mine workers. It is preferable that the components of the means for communication 102, supplying water 106, supplying fresh air 104, food or liquid food 108, or first aid kit be mounted at the bottom of the mine passage 90 in order to reduce the risk of being crushed and to permit the trapped mine worker to straddle the components while moving through the passage 90.

In another embodiment, FIG. 1B depicts a life source conduit 116 implanted within the second trench 32A as described above. Different portions of the mine may have only the life source conduit 116, only the mine conduit 32, or may have both. The life source conduit 116 can provide the communication means 102 for communicating to people external to the mine 12, the means 104 for supplying fresh air, or both. The life source conduit 116 can provide the means 106 for supplying water, food 108, the first aid kit, or any combination thereof.

The life source conduit 116 can be much smaller than the mine conduit 30, even though the life source conduit 116 is manufactured and installed similarly to the mine conduit 30, i.e., an assembly of pipes. For example, the life source conduit 116 can include a first end and a second end opposite the life source conduit first end. The life source conduit 116 can be constructed of a series of pipes, as described above, to withstand an impact on the top due to a roof collapse. By partially or fully burying the life source conduit 116, the vertical force and pressure from a collapse are transferred to the surrounding earth or soil. Hence, the life source conduit 116 can withstand a roof collapse and maintain structural and mechanical integrity. The life source conduit 116 can be provided independently, or in conjunction, with the mine conduit 30. When provided in conjunction with the mine conduit 30, as shown in FIG. 1B, the life source conduit can be positioned just outside of the mine conduit 30. The life source conduit can also be connected to portals similar to the portals 100 of the mine conduit 30.

Methods of trenching and/or installation of conduits are also provided. It is to be understood that, although specific reference is made to trench 32 and mine conduit 30, these methods also apply to the trench 32A and conduit 116, as well.

A method of installing the mine conduit 30 for enhancing the safety and welfare of underground miners in the event of an emergency is provided. A plurality of pipes 74 can be provided. Referring to FIG. 3, at least one trench 32 can be plowed into the mine floor 20. One method of plowing trench 32 can be by the trenching machine. Referring to FIGS. 4A and 4B, the mine conduit 30 can be formed by securely engaging the first connection means 84 of one pipe 74 with the second connection means 86 of an abutting pipe 88. A portion of the mine conduit 30 can be implanted into the plowed trench 32 of the mine 12, as shown in FIG. 1A. Referring to FIG. 4A, at least one portal 100, preferably with a cap 114, can be inserted at an effective distance from one of the first and second ends 70, 72 of the mine conduit 30. A communication means 102, a means 104 for supplying fresh air, or both can be installed into the mine conduit 30. In addition, at least one of the following can be installed: a means 106 for supplying water, food 108, or a first aid kit.

The mine safety system 10 can also provide a way of escape in the event of a collapse between the mine workers and an exit out of the mine 12. In one embodiment, the passage 90 of the mine conduit 30 can be sized for a mine worker to crawl through. Here, the passage 90 is preferably substantially clear of any other conduits. After the collapse, the mine worker in the distal area A can remove the cap 114 of the portal 100. Before entering into the mine conduit 30, the mine worker may merely decide to use the communication means 102 to communicate to the outside world of the mine conduit 30. Optionally, the mine worker may decide to enter into the mine conduit 30. After entering into the passage 90 of the mine conduit 30, the mine worker may crawl past the collapsed area C to another portal 100 located in the proximal area B away from the collapsed area C. The cap 114 can then be removed from the inside of the mine conduit 30 to allow the mine worker to escape. Alternatively, the mine worker may crawl past the collapsed area C all the way until safety is reached. This may be preferred method in mines that have a greater risk of collapse.

In another embodiment, the use of the mine conduit 30 and/or life source conduit 116 can sustain the mine workers in the distal area A until rescue. In this embodiment, the mine workers would not crawl through the passage 90 to safety. Rather, after the collapse, the mine worker would remain in the distal area A distal to the collapse area C and wait for rescue, while being sustained by the portal 100 such as in FIGS. 5A and 5B. In this embodiment, it may be more likely to find not only a communication means 102 and a means 104 for supplying fresh air, but also a means for supplying water 106, food 108, a first aid kit, or any combination thereof. This may be preferred method in mines having a lesser risk of collapse. FIG. 6 depicts one embodiment of a life source conduit having a communication means 102, a means 104 for supplying fresh air, and a means for supplying water 106.

In accordance with the provisions of the patent statutes, the present invention has been described in what is considered to represent its preferred embodiment. However, it should be noted that the invention can be practiced otherwise than as specifically illustrated and described.

1. A mine safety system for a mine having a floor, a roof, and a pair of sidewalls, the system comprising:
a trench formed in said mine floor;
a mine conduit disposed in the trench, the mine conduit including a wall defining an internal passage;
a portal positioned along the mine conduit, the portal configured to provide external access to the internal passage of the mine conduit; and
at least one of a telecommunication means and a ventilation supply means disposed within the internal passage of the mine conduit, the telecommunication means and the ventilation supply means being accessible through the portal,
where the trench has a depth sized to be at least 60% of a height of a cross-section of the mine conduit so that a substantial portion of the mine conduit is buried within said mine floor.

2. The system of claim 1, wherein the trench is formed having a cross-section sized and shaped similar to a portion of the cross-section of the mine conduit.

3. The system of claim 2, wherein the cross-section of the mine conduit is circular, and a portion of the cross-section of the trench is arcuate.

4. The system of claim 2, wherein the mine conduit comprises a series of pipes coupled to one another to form the mine conduit.

5. The system of claim 4, wherein the pipe comprises a plastic material.

6. The system of claim 4, wherein the pipe comprises a corrugated high density polyethylene pipe.

7. The system of claim 1, further comprising at least one of a water supply means and a nutrient supply means disposed within the internal passage of the mine conduit, the water supply means and the nutrient supply means being accessible through the portal.

8. The system of claim 7, where at least one of the telecommunication means, the ventilation supply means, the water supply means, and the nutrient supply means is located within one or more supply conduits disposed within the internal passage of the mine conduit.

9. The system of claim 1, wherein the passage of the mine conduit is configured for a person to crawl through.

10. The system of claim 1 further comprising a plurality of portals spaced apart equally from one another by an effective distance.

11. A method of installing a mine safety system in a mine having a floor, a roof, and sidewalls, comprising:
providing a mine conduit having a wall defining an internal passage;
forming a trench at a selected depth in the floor of said mine, where the selected depth sized to be at least 60% of a height of a cross-section of the mine conduit;
inserting the mine conduit within the trench so that at least a substantial portion of the mine conduit is within the trench;
forming a portal in the wall of the mine conduit, the portal configured to provide external access to the internal passage of the mine conduit; and
backfilling the trench around an exterior surface of the mine conduit, so that so that a substantial portion of the mine conduit is buried within said mine floor.

12. The method of claim 11, wherein the trench is formed having a cross-section sized and shaped similar to a portion of the cross-section of the mine conduit.

13. The method of claim 12, wherein the cross-section of the mine conduit is circular, and a portion of the cross-section of the trench is arcuate.

14. The method of claim 11, wherein the trench is formed by a rotating cutter drum having a plurality of cutting teeth mounted on the peripheral surface thereof, the plurality of cutting teeth and the peripheral surface being configured to form the trench having an arcuate bottom surface.

15. The method of claim 11, wherein the plurality of cutting teeth and the peripheral surface being configured to further form the trench having substantially vertical sidewalls coupled to the arcuate bottom surface.

16. The method of claim 11 further comprising providing at least one of a telecommunication means and a ventilation supply means within the internal passage of the mine conduit, the telecommunication means and the ventilation supply means being accessible through the portal.

17. The method of claim 16 further comprising providing at least one of a water supply means and a nutrient supply means within the internal passage of the mine conduit, the water supply means and the nutrient supply means being accessible through the portal.

18. The method of claim 11, wherein the passage of the mine conduit is configured for a person to crawl through.

19. The method of claim 12, wherein the pipe comprises a high density polyethylene pipe.

20. A cutter drum for a trenching machine comprising a cylindrical member configured to rotate about a horizontal axis, the cylindrical member having a curved peripheral surface of an axial width uniformly spaced from the horizontal axis, a plurality of cutting tooth assemblies mounted to the peripheral surface, each cutting tooth extending outward from the peripheral surface and having a distal tip, the distal tips of the cutting tooth assemblies being configured and arranged to form an arcuate periphery capable of trenching a trench having an arcuate bottom surface.

21. The cutter drum of claim 20, wherein the cutting tooth assemblies are spaced apart from one another along the axial width of the peripheral surface, where the distal tip of an outer cutting tooth assembly is spaced from the peripheral surface at a first distance, the distal tip of an intermediate cutting tooth assembly is spaced from the peripheral surface at a second distance greater than the first distance.

22. The cutter drum of claim 21, wherein the cutting tooth assemblies each comprises a support member and a cutting tooth, where the support member is configured to receive the cutting tooth, where the support member has an elevation length from the peripheral surface that is sized differently depending on the location of the cutting tooth assemblies along the axial width of the peripheral surface.

23. The cutter drum of claim 21, wherein the cutting tooth assemblies are spaced apart from one another axially and circumferentially to define a substantially helical pattern.

24. The cutter drum of claim 23, wherein a first series of cutting tooth assemblies are spaced apart from one another axially and circumferentially to define a first substantially helical pattern, and a second series of cutting tooth assemblies are spaced apart from one another axially and circumferentially to define a second substantially helical pattern, where the first helical patterns has a first end along a first outer end of the peripheral surface and a second end along an intermediate portion of the peripheral surface, the second helical patterns has a first end along a second outer end of the peripheral surface, opposite the first outer end, and a second end along the intermediate portion of the peripheral surface.

25. The cutter drum of claim 23, wherein each cutting tooth is oriented to point toward the intermediate portion of the peripheral surface.

26. The cutter drum of claim 23, wherein the first helical pattern and the second helical pattern are circumferentially offset by an angle of up to about 40 degrees.
